(19) United States
(12) Patent Application Publication
(10) Pub. No.: US 2002/0112084 A1
(43) Pub. Date: Aug. 15, 2002

(54) Methods, systems, and computer program products for controlling devices through a network via a network translation device

(76) Inventors: Gary D. Deen, Durham, NC (US); Brian T. Webb, Raleigh, NC (US); Gregory T. Knowles, Raleigh, NC (US); Bradley T. Marchesseault, Cary, NC (US)

Correspondence Address: MYERS BIGEL SIBLEY & SAJOVEC, PO BOX 37428, RALEIGH, NC, 27627, US

(21) Appl. No.: 09/782,809

(22) Filed: Feb. 14, 2001

Related U.S. Application Data
(60) Provisional application No. 60/258,658, filed on Dec. 29, 2000.

(51) Int. Cl. G06F 15/16

(52) U.S. Cl. 709/250

(57) ABSTRACT

Methods, systems, and computer program products are provided for controlling devices through a network via a network translation device. The network translation device determines whether a first device, such as a legacy device, has functionality that is controllable via a first protocol (e.g., a device connectivity protocol). If the first device has functionality that is controllable via the first protocol, then the network translation device sends the first device functionality information to a second device (i.e., a controlling device). The network translation device may include one or more non-volatile memory modules that are respectively associated with communication ports on the network translation device and contain data associated with the functionality provided by a device that is connected to the respective communication port. The memory modules may also include data for configuring the communication port for communication with the device connected thereto.

This application claims the benefit of Provisional Application Serial No. 60/258,658, filed Dec. 29, 2000, entitled Methods, Systems and Computer Program Products for Controlling Legacy Devices Through a Network Via a Network Translation Device, the disclosure of which is hereby incorporated herein by reference.

### BACKGROUND OF THE INVENTION

The present invention relates generally to the field of computer networking and, more particularly, to controlling devices and/or accessing services provided by devices through a network.

One way that two computers pass data between each other is via a serial connection. Broadly stated, a serial connection is a specific type of communication protocol in which one computer sends sequential bits of data over a communication medium (e.g., a wire or cable) to another computer at an agreed upon rate and format. Thus, a typical serial connection involves a serial communication port on each computer, software on each computer to control the communication process, and the communication medium. A computer may use a serial connection to control another computer and/or access services or functionality provided by another computer. For example, a computer may use a serial connection to send data to a printer along with serial commands that instruct the printer how the data is to be printed.

A conventional serial connection between two computers in which a cable is used as the communication medium is illustrated in FIG. 1. Computer 1 and Computer 2 each include a processor that is communicatively coupled to a memory having a control program stored thereon. In addition, each processor is communicatively coupled to a serial communication port. As illustrated in FIG. 1, the serial cable is directly coupled to the serial ports on each computer. When one computer needs to communicate with the other, its control program configures the serial port to transmit data at a data transfer rate and in a format that the other computer can receive and process. Once the serial port is configured, the data is transmitted and received at the serial port of the other computer. The other computer receives and processes the data and may send data back to the transmitting computer in like fashion.

The serial connection illustrated in FIG. 1 is generally straightforward as the two computers are directly connected to one another and data is transferred using a communication protocol (e.g., a data transfer rate and format) that is controlled by software residing on each computer. With the advent of the Internet and the local area networks (LANs) and wide area networks (WANs) that make up the Internet, however, new serial connection devices have emerged that may facilitate serial connections between computers without the need for the computers to be directly connected to each other. These serial connection devices are sometimes called “network serial devices” and typically are implemented as computers with a network communication port, such as an Ethernet port, and one or more serial communication ports. Network serial devices may be configured with software that allows them to service multiple types of legacy serial communication programs. As a result, network serial devices may be integrated into networks comprising various types of legacy computers and devices often with little or no modification.

FIGS. 2 and 3 illustrate two exemplary networks that include conventional network serial devices. Referring now to FIG. 2, a network serial device is shown that comprises a processor that is communicatively coupled to both a memory and a network port. The memory includes a control program that may be used to facilitate a serial connection between Computer 1 and Computer 2. Computer 1 and Computer 2 are configured similarly to the two computers shown in FIG. 1 with the exception that the programs on Computer 1 and Computer 2 are designed to allow the computers to communicate with the network serial device using the appropriate communication protocol for the network. Thus, when Computer 1 wants to establish a serial connection with Computer 2, Computer 1 may send a message to the network serial device requesting a serial connection with Computer 2 or may invoke a method on the network serial device based on an application programming interface (API) provided by the network serial device to configure a serial connection with Computer 2. The network serial device then establishes a connection with Computer 2 over the network and proceeds to relay data transmitted from Computer 1 to Computer 2. Because two network connections are used in this architecture, the serial connection between Computer 1 and Computer 2 through the network serial device may be viewed as a virtual serial connection as the data is actually transmitted using a network protocol over network ports.

Referring now to FIG. 3, another embodiment of a conventional network serial device is shown in which the network serial device includes a serial port for establishing a direct serial connection between the network serial device and Computer 2. Computer 1 can establish a serial connection with Computer 2 by initially establishing communication with the network serial device as discussed above with respect to FIG. 2. Rather than setting up a network connection with Computer 2, however, the network serial device sets up a direct serial connection with Computer 2 as discussed above with respect to FIG. 1. The network serial device receives serial data from Computer 1 via a network connection and proceeds to relay the serial data to Computer 2 via a direct serial connection.

Unfortunately, to establish a serial connection via a conventional network serial device, a computer may have to include software designed to send a message to the network serial device and/or to make API call(s) to method(s) on the network serial device to configure a serial connection. Alternatively, a computer may establish a direct serial connection to another device on a network. But establishing such a direct connection typically requires port and/or network address information, which may need to be maintained on the computer or hard coded into the computer's communication software.

### SUMMARY OF THE INVENTION

Embodiments of the present invention include methods, systems, and computer program products for controlling devices through a network via a network translation device. For example, a network translation device determines whether a first device, such as a legacy device, has functionality that is controllable via a first protocol (e.g., a device connectivity protocol). If the first device has functionality that is controllable via the first protocol, then the network translation device sends the first device functionality information to a second device (i.e., a controlling device). Certain devices, such as legacy devices, may be unable to communicate their existence to other devices in a network because they are unable to run the particular device connectivity protocol software that the network uses to integrate new devices. Advantageously, in accordance with the present invention, a network translation device may inform one or more potential controlling devices in a network about the existence of a device in the network that is unable to run the device connectivity protocol software (e.g., a legacy device) and the functionality that may be provided by that device.

In accordance with further embodiments of the present invention, before the network translation device sends the first device functionality information to the second device (i.e., controlling device), the network translation device notifies the second device that the first device has functionality that is controllable via the first protocol (e.g., the device connectivity protocol). The network translation device then waits until it receives a request from the second device for the first device functionality information.

In accordance with still further embodiments of the present invention, the network translation device may determine whether the first device has functionality that is controllable via the first protocol by associating a memory module with the first device. The network translation device may examine the memory module to determine if the memory module contains data that is associated with functionality provided by the first device. The network translation device may send this data to the second device upon request as discussed hereinabove.

For added flexibility, the memory module may be embodied as a non-volatile memory cartridge that may be swapped in and out of the network translation device. An array of devices may be supported by the network translation device as memory cartridges may be created that contain data associated with the functionality of the respective devices. The appropriate cartridges may then be installed into the network translation device based on the particular device(s) present in the network.

In still further embodiments of the present invention, the memory module is associated with a communication port and has communication port configuration data stored thereon. Based on this data, the communication port may be configured for communication. For example, the communication port may be a serial communication port for communication with a legacy serial device. Accordingly, the communication port configuration data may include a baud rate and a format for arranging data bits, stop bits, and parity bits in a serial transmission.

Even though the first device may not be able to run the first protocol software (e.g., the device connectivity protocol software) embodiments of the present invention may allow the second device (i.e., the controlling device) to control the first device and/or access the functionality of the first device through the network translation device. Specifically, if the first device has functionality that is controllable via the first protocol, then the second device may send a command for invoking functionality of the first device to the network translation device using the first protocol (e.g., the device connectivity protocol). The network translation device translates the command from the first protocol format into a second protocol format that is compatible with the first device. For example, the first device may communicate with the network translation device by using a predefined library of serial commands (e.g., data strings). Accordingly, the network translation device may translate a command issued by the second device in a device connectivity protocol format into a serial command that is compatible with the first device. Finally, the network translation device sends the translated command to the first device.

Advantageously, embodiments of the present invention may allow a controlling device to control a device, such as a legacy device, and/or access the services provided by the device without the need to maintain knowledge of the particular commands used to drive or access the device. Instead, a device connectivity protocol, such as the Jini protocol, the Universal Plug and Play (UPnP) protocol, and the Salutation protocol, may be used to issue commands to the device, which are then translated by the network translation device into commands that are compatible with the device. In other words, from the perspective of the controlling device, the device may be communicated with and controlled as if it were capable of running the device connectivity protocol that is in use on the network due to the translation provided by the network translation device.

While the present invention has been described above primarily with respect to method and system aspects of the invention, it will be understood that the present invention may be embodied as methods, systems, and/or computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a conventional direct serial connection between two computers;

FIGS. 2 and 3 are block diagrams of conventional serial connections between two computers over a network via a network serial device;

FIG. 4 is a block diagram that illustrates network translation devices for controlling devices through a network in accordance with embodiments of the present invention;

FIG. 5 is a software architecture block diagram for the network translation device of FIG. 4 in accordance with embodiments of the present invention; and

FIGS. 6-8 are flowcharts that illustrate exemplary operations for controlling devices through a network via a network translation device in accordance with embodiments of the present invention.

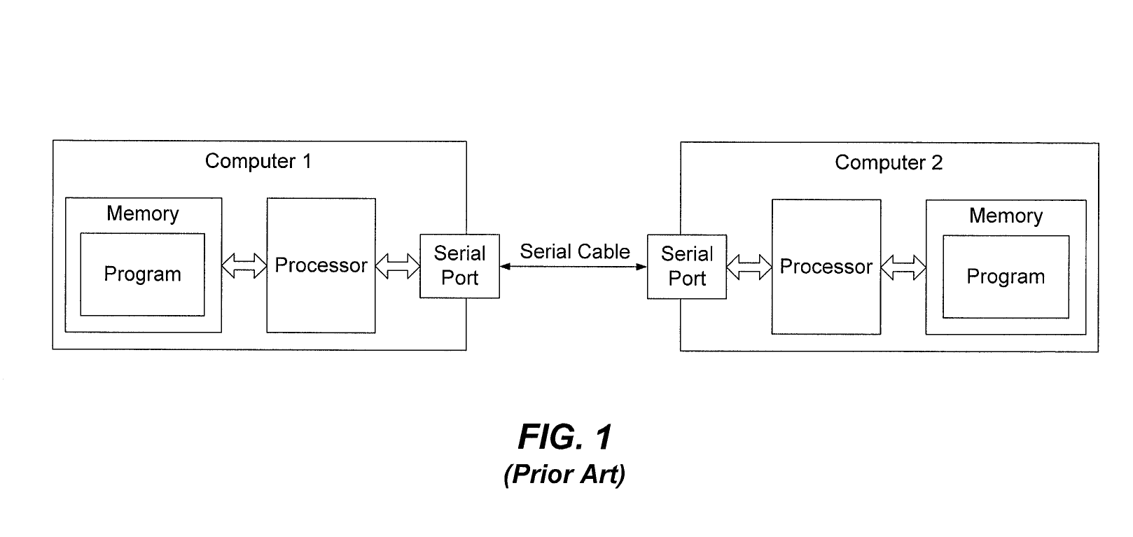

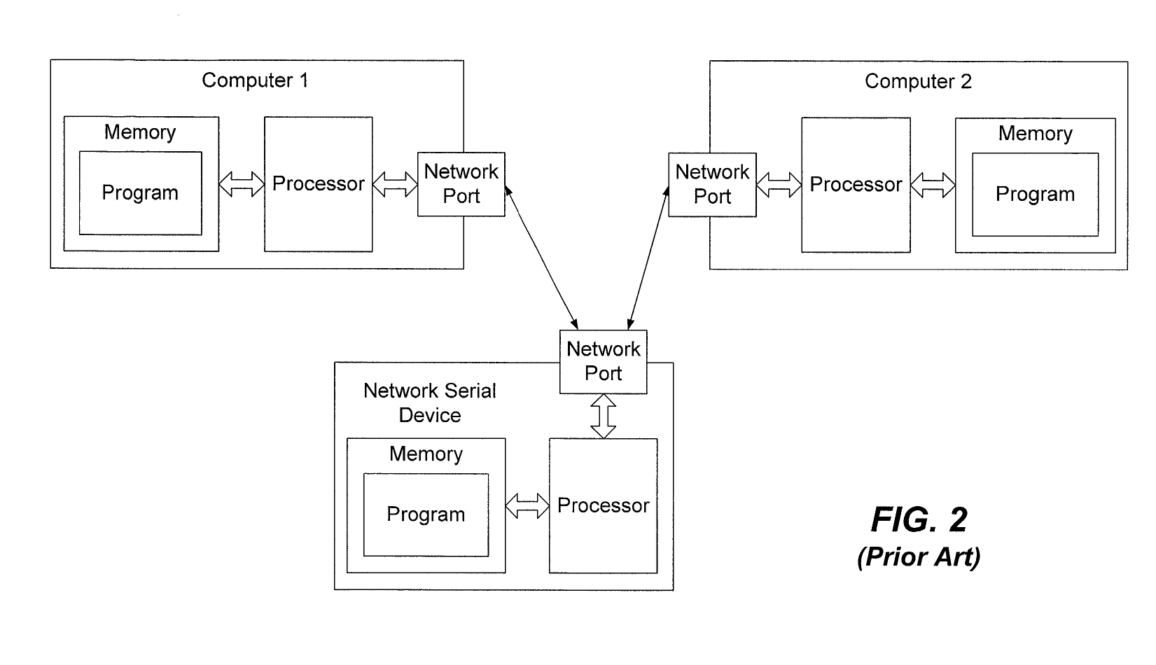

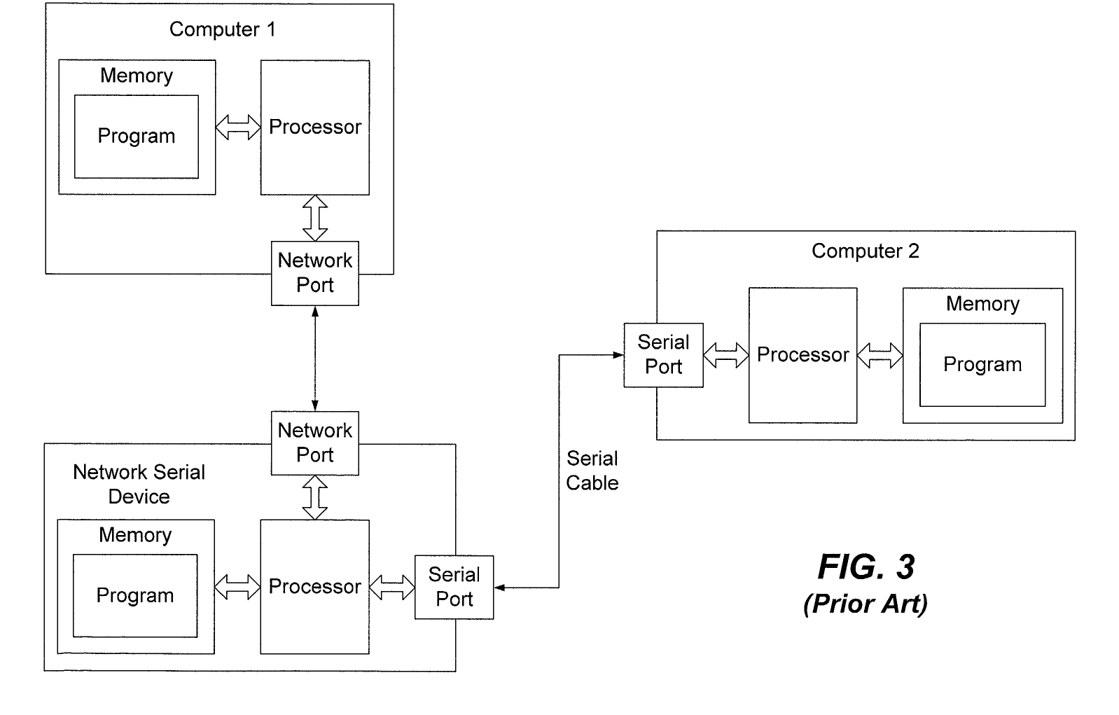

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention is described herein in the context of controlling legacy devices through a network via a network translation device. In particular, for purposes of illustration, exemplary embodiments of the present invention are illustrated and discussed hereafter in which the legacy devices communicate using a serial connection. Nevertheless, it will be understood that the concepts and principles of the present invention may be applied to legacy devices that use alternative communication protocols or standards. Furthermore, the concepts and principles of the present invention are generally applicable to networks that include devices (legacy and/or contemporary (i.e., non-legacy)) that do not run a device connectivity protocol that other devices on the network use, for example, to announce their presence on the network, to share information regarding their functional capabilities, and to provide access to services and information.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

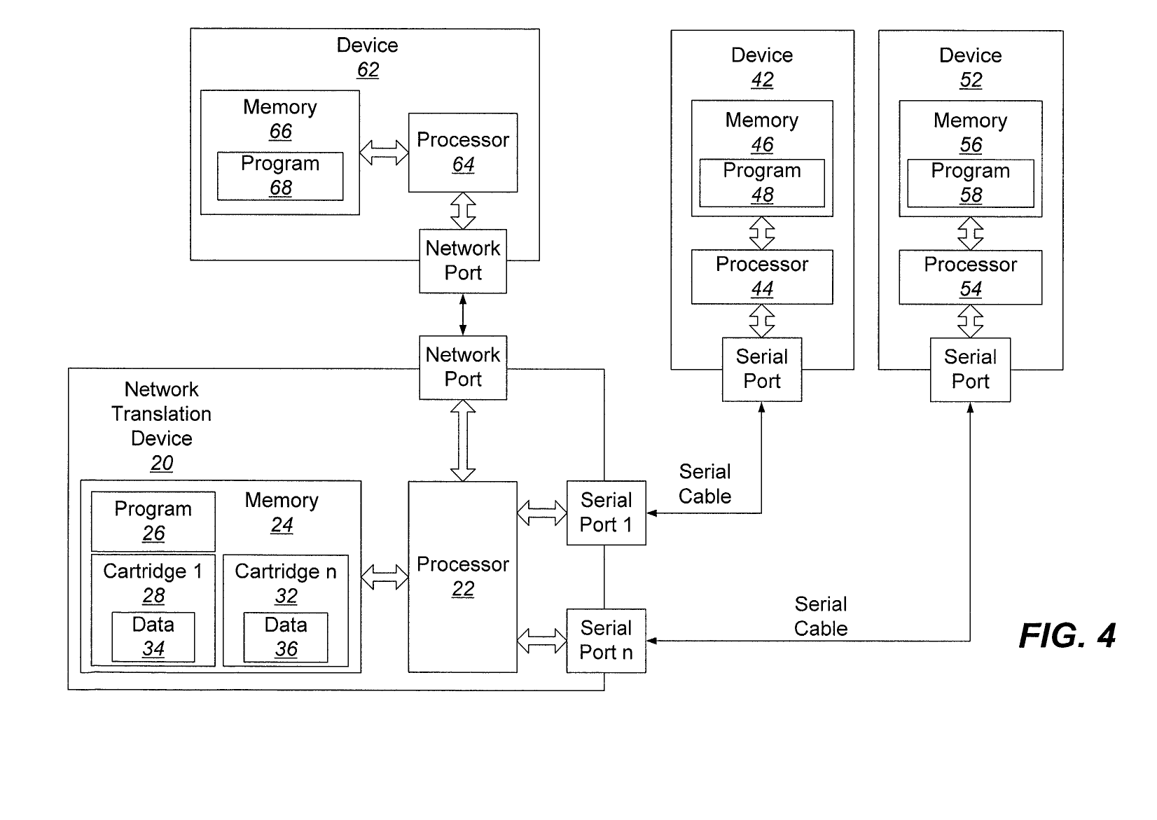

Referring now to FIG. 4, a network translation device 20, in accordance with embodiments of the present invention, comprises a processor 22 that is communicatively coupled to a memory 24, a network port, and a plurality of serial ports, which are illustrated as serial port 1 and serial port n. The memory 24 includes a program 26 and a pair of memory modules: cartridge 1 28 and cartridge n 32. The modules comprising the program 26 will be discussed in more detail hereinafter. Cartridge 1 28 and cartridge n 32 are associated with serial port 1 and serial port n, respectively. Cartridge 1 28 includes a data module 34 and cartridge n 32 includes a data module 36.

The network translation device 20 is directly connected to a device 42 through serial port 1 via a serial cable. It will be understood that the serial cable is an exemplary communication medium and that alternative communication mediums, such as a wire, an infrared link, a radiotelephone channel, etc. may be used as the communication medium. The device 42 includes a processor 44 that is communicatively coupled to a memory 46 and a serial port. The memory 46 includes a program 48 that, among other things, implements a serial communication protocol for communicating with the network serial device 20.

The network translation device 20 is also directly connected to a device 52 through serial port n via a serial cable. As discussed above, the serial cable is an exemplary communication medium and alternative communication mediums may be used. The device 52 includes a processor 54 that is communicatively coupled to a memory 56 and a serial port. The memory 56 includes a program 58 that, among other things, implements a serial communication protocol for communicating with the network serial device 20.

In addition to the serial connections with devices 42 and 52, the network translation device 20 may communicate with a device 62 over a network, such as the Internet, a wide area network (WAN), a local area network (LAN), a virtual private network (VPN), and/or combinations thereof. The device 62 includes a processor 64 that is communicatively coupled to a memory 66 and a network port. The memory 66 includes a program 68 that, among other things, implements a network communication protocol for communicating with the network translation device 20.

Devices 42, 52, and 62 may be embodied as information appliances, which includes, but is not limited to, traditional computers and workstations, facsimile machines, printers, telephones (wireless and wireline), personal digital assistants (PDAs), copiers, hand scanners, foil projectors, and the like.

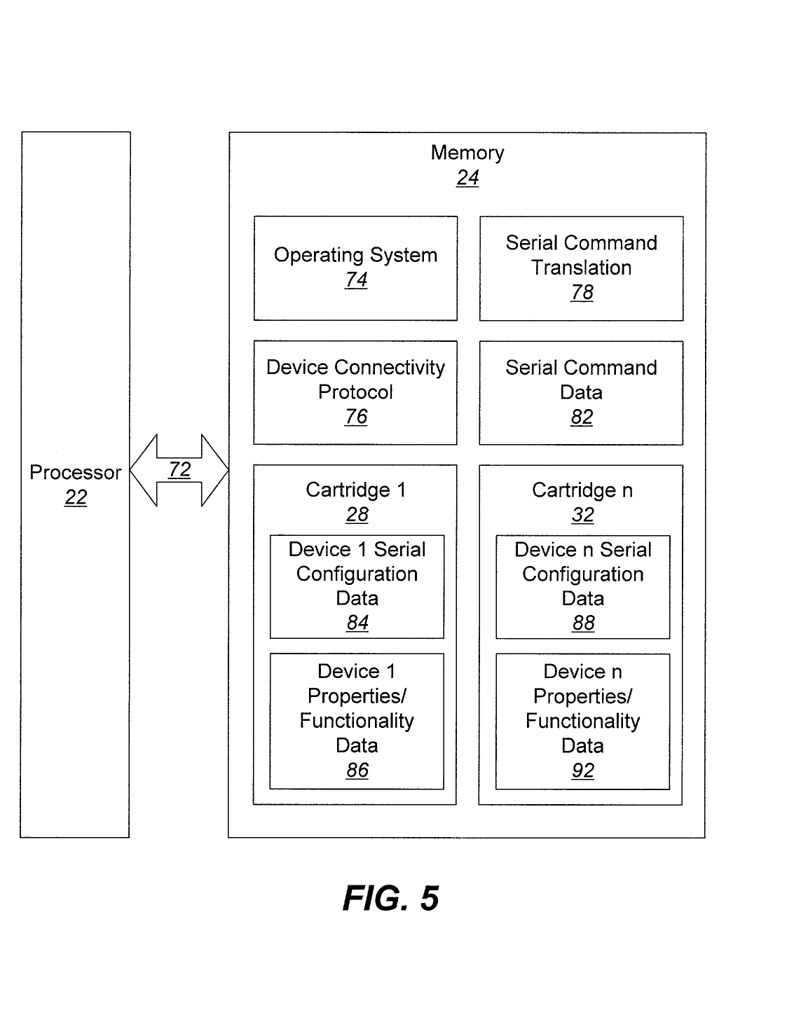

FIG. 5 illustrates the processor 22 and memory 24 in more detail. In accordance with embodiments of the present invention, the processor 22 communicates with the memory 24 via an address/data bus 72. The processor 22 may be, for example, a commercially available or custom microprocessor. The memory 24 is representative of the overall hierarchy of memory devices containing the software and data used to facilitate the control of devices in a computer network in accordance with embodiments of the present invention. The main memory 24 may include, but is not limited to, the following types of devices: cache, ROM, PROM, EPROM, EEPROM, flash, SRAM, and DRAM.

As shown in FIG. 5, the memory 24 may hold at least four major categories of software and data, which comprise the program 26: the operating system 74, the device connectivity protocol program module 76, the serial command translation program module 78, and the serial command data module 82. In addition to these four program/data modules, the memory 24 also includes the cartridge 1 28 and cartridge n 32 modules. The operating system 74 controls the operation of the computer system. In particular, the operating system 74 may manage the computer system's resources and may coordinate execution of programs by the processor 22.

The device connectivity protocol module 76 may be embodied using network technology that enables devices to join together in a network and use services provided by the respective devices with generally minimal configuration overhead. For example, the device connectivity protocol module 76 may allow devices in the network to announce their presence, convey their capabilities/functionality upon request, learn about the presence and capabilities/functionality of other devices in the network, and to use the capabilities/functionality provided by other devices in the network. Examples of technologies that may be used to implement the device connectivity protocol module 76 include the Jini protocol, which is based on Java technology, the Universal Plug and Play (UPnP) protocol, and the Salutation protocol.

Referring again to FIG. 4, the program 68 running on device 62 includes software to implement the device connectivity protocol in addition to the software used to implement the communication protocol for the underlying network (e.g. TCP/IP, token ring protocol, Ethernet protocol, etc.). The programs 48 and 58 running on devices 42 and 52, respectively, however, do not include software for implementing the device connectivity protocol. Devices 42 and 52 may not announce their presence or provide access to their capabilities/functionality via the device connectivity protocol. Devices 42 and 52 do not run the device connectivity protocol used by other devices in the network and may be referred to herein as legacy devices. It will be understood, however, that, in accordance with embodiments of the present invention, devices 42 and 52 may be legacy and/or contemporary devices that do not run a device connectivity protocol that other devices on the network use, for example, to announce their presence on the network, to share information regarding their functional capabilities, and to provide access to services and information.

Returning to FIG. 5, the serial command translation module 78 is configured to receive commands from devices, such as device 62, that are formatted in accordance with the device connectivity protocol and to translate those commands into a serial format that may be transmitted to a legacy device, such as device 42 or device 52. The serial command data module 82 includes a library of serial commands that the serial command translation module 78 uses in translating the device connectivity protocol command into an appropriate serial command for a legacy device.

The cartridge 1 28 module includes two types of data: a device 1 serial configuration data module 84 and a device 1 properties/functionality data module 86. The device 1 serial configuration data module 84 includes the data that may be used to configure serial port 1 of the network translation device 20 for serial communication with the device that is connected to serial port 1. Based on the example shown in FIG. 4, device 42 is connected to serial port 1; therefore, the device 1 serial configuration data module 84 includes those data that are used to configure serial port 1 for serial communication with device 42. These data may include the baud rate and the format for arranging data bits, stop bits, and parity bits in a serial transmission.

The device 1 properties/functionality data module 86 includes data that is associated with the properties, capabilities, and/or functionality of the device that is connected to serial port 1 and may be controllable, for example, by another device through the device connectivity protocol 76. Based on the example shown in FIG. 4, the device 1 properties/functionality data module 86 includes those data associated with the properties, capabilities, and/or functionality of device 42 that may be controlled, for example, by device 62 through the device connectivity protocol 76.

Cartridge n 32 is configured in like manner as cartridge 1 28 and includes a device n serial configuration data module 88 and a device n properties/functionality data module 92. Based on the example shown in FIG. 4, the device n serial configuration data module 88 and the device n properties/functionality data module 92 include data that are associated with device 52.

The cartridge 1 28 and the cartridge n 32 may be implemented as non-volatile memory cartridges, such as iButton and SmartMedia cards, that may be swapped in and out of slots in the network translation device 20. In this manner, the network translation device 20 may support an array of legacy device types as cartridges may be developed that contain the serial configuration data and the properties/functionality data for the various legacy devices.

Although FIGS. 4 and 5 illustrate an exemplary software architecture that may be used for controlling devices through a network via a network translation device, it will be understood that the present invention is not limited to such a configuration but is intended to encompass any configuration capable of carrying out the operations described herein.

Computer program code for carrying out operations of the present invention may be written in an object-oriented programming language, such as Java, Smalltalk, or C++. Computer program code for carrying out operations of the present invention may also, however, be written in conventional procedural programming languages, such as the C programming language or compiled Basic (CBASIC). Furthermore, some modules or routines may be written in assembly language or even micro-code to enhance performance and/or memory usage.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

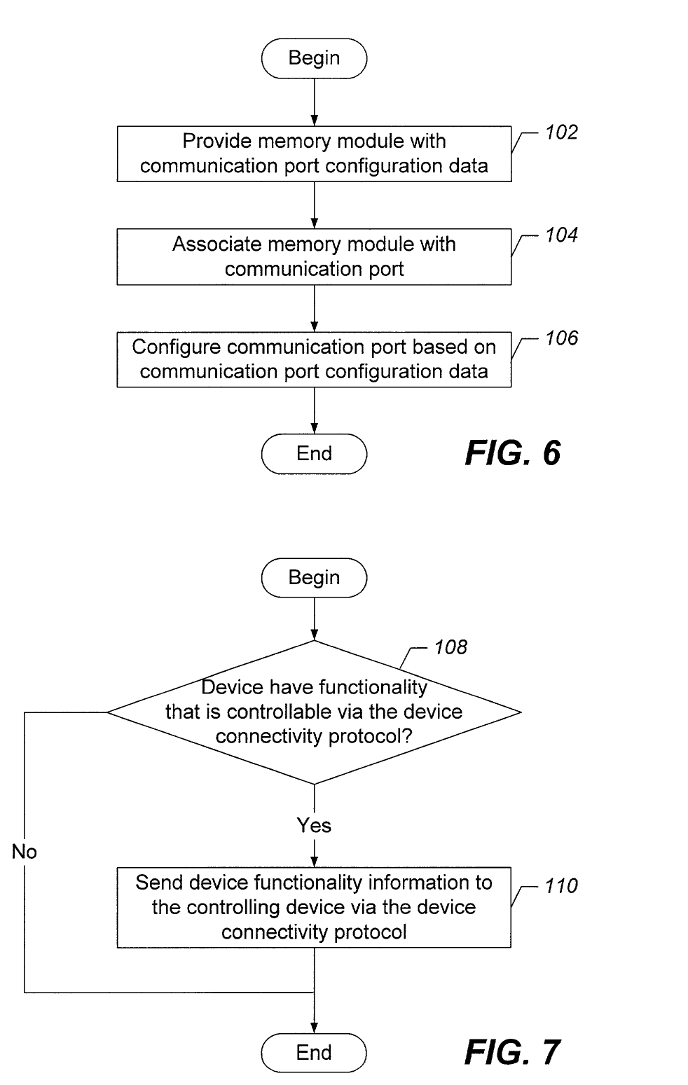

With reference to the flowcharts of FIGS. 6-8 and the block diagrams of FIGS. 4 and 5, exemplary operations of methods, systems, and computer program products for controlling devices through a network via a network translation device, in accordance with embodiments of the present invention, will be described hereafter. Referring now to FIG. 6, operations begin at block 102 where the network translation device 20 provides a memory module, such as cartridge 1 28, that includes the device 1 serial configuration data module 84. The device 1 serial configuration data module 84 includes data that is used to configure serial port 1 of the network translation device 20 for serial communication. As indicated by block 104, the cartridge 1 28 is associated with serial port 1. Specifically, the device 1 serial configuration data module 84 includes data that is designed to configure serial port 1 for communication with device 42, which is connected to serial port 1. The data may include a baud rate and a format for arranging data bits, stop bits, and parity bits in a serial transmission as discussed hereinabove. At block 106, the network translation device configures serial port 1 based on the data in the device 1 serial configuration data module 84 for serial communication with device 42. Thus, through the use of the cartridge 1 28, the present invention may allow a serial port to be auto-configured without the need for another device on the network to make an API call across the network to configure the serial port.

In addition to configuring a serial port for service, the present invention may also allow a controlling device, such as device 62 in FIG. 4, to access functionality and services provided by a legacy device. Referring now to FIG. 7, operations in accordance with further embodiments of the present invention begin at block 108 where the network translation device 20 determines whether a legacy device, such as device 42 or device 52, has functionality that is controllable via the device connectivity protocol. If the legacy device does have functionality that is controllable via the device connectivity protocol, then the network translation device sends the device functionality information to a controlling device, such as device 62, at block 110. Thus, the network translation device 20 may inform other potential controlling devices on the network about the existence of legacy devices using the device connectivity protocol based on the data that the network translation device 20 has stored on the memory modules (i.e., the cartridge 1 28 and the cartridge n 32) concerning the legacy devices in the network.

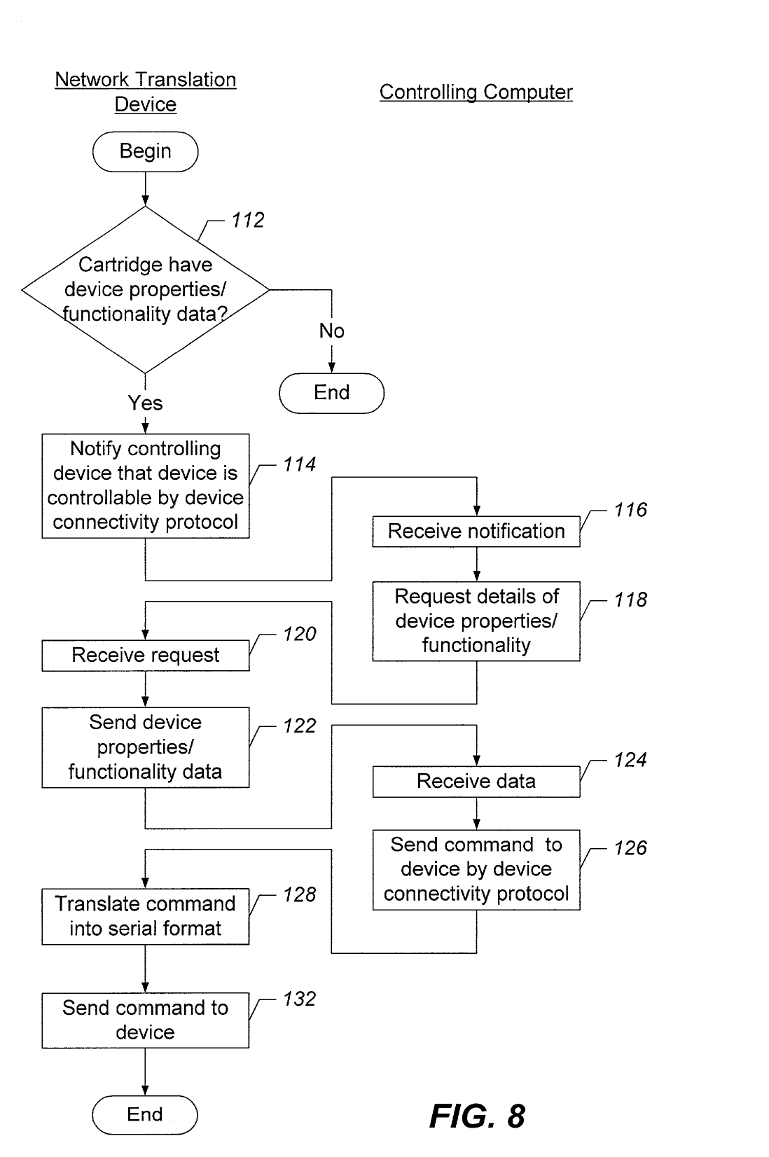

Further embodiments of the present invention for allowing a controlling device, such as device 62 in FIG. 4, to access functionality and services provided by a device are illustrated in FIG. 8. At block 112, the network translation device determines whether a cartridge, such as cartridge 1 28, includes a device 1 properties/functionality data module 86. If the cartridge 1 28 includes the device 1 properties/functionality data module 86, then the network translation device 20 determines that the legacy device connected to serial port 1 (device 42 in FIG. 4) includes functionality that is controllable by another device (e.g., device 62) via the device connectivity protocol. At block 114, the network translation device 20 notifies a controlling device, such as device 62, using the device connectivity protocol module 76 that device 42 is controllable via the device connectivity protocol.

At block 116, the device 62 receives notification via the device connectivity protocol about the existence of the legacy device 42 and that the device 42 is controllable via the device connectivity protocol. The controlling device 62 then proceeds to request details about the properties and functionality provided by the device 42 by sending a message to the network translation device 20 via the device connectivity protocol at block 118.

The network translation device 20 receives the request for details concerning the properties and functionality of the legacy device 42 at block 120 and responds by reading the data contained in the device 1 properties/functionality data module 86, which is associated with the device 42, and then sending this data to the device 62 using the device connectivity protocol module 76 at block 122.

The controlling device 62 receives the data containing the details of the properties and functionality of the legacy device 42 at block 124. Based on the functionality provided by the device 42, the device 62 may issue a command to the device 42 using the device connectivity protocol at block 126. The network translation device 20 receives the command destined for the legacy device 42 and rather than forwarding this command on to the device 42, translates the command into a serial format at block 128. Specifically, the serial command translation module 78 translates the command from the device connectivity protocol format into an appropriate serial command selected from the serial command data module 82. The network translation device 20 then transmits the translated command to the legacy device 42 in serial format at block 132.

The flowcharts of FIGS. 6-8 illustrate the architecture, functionality, and operations of an exemplary implementation of the network translation device 20 software. In this regard, each block represents a module, segment, or portion of code, which comprises one or more executable instructions for implementing the specified logical function(s). It should also be noted that in other embodiments, the functions noted in the blocks may occur out of the order noted in FIGS. 6-8. For example, two blocks shown in succession may be executed substantially concurrently or the blocks may be executed in the reverse order, depending on the functionality involved.

From the foregoing it can readily be seen that, in accordance with the present invention, a network translation device may allow a controlling device to control a device, such as a legacy device, or to invoke the functionality of a device without the need to maintain knowledge of the protocol and/or commands used to communicate with the device. Advantageously, from the point of view of a controlling device, the devices to be controlled appear like any other device on the network because the network translation device may act as an agent for these devices in implementing the device connectivity protocol and translating commands from controlling devices, which are formatted according to the device connectivity protocol into appropriate commands that are based on the communication protocols used by the devices to be controlled.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

We claim:

1. A method of configuring a communication port for communication with a device, comprising the steps of:
providing a memory module having communication port configuration data that is associated with the device stored thereon;
associating the memory module with the communication port; and
configuring the communication port based on the communication port configuration data stored on the memory module.

2. A method as recited in claim 1, wherein the memory module is a nonvolatile memory cartridge.

3. A method as recited in claim 2, wherein the step of associating the memory module with the communication port comprises the steps of:
associating a memory module slot with the communication port; and
inserting the non-volatile memory cartridge into the memory module slot.

4. A method as recited in claim 1, wherein the communication port is a serial port and the communication port configuration data comprises a baud rate and a format for arranging data bits, stop bits, and parity bits in a serial transmission.

5. A method of controlling a first device by a second device via communication with a network translation device, comprising the steps of:
determining at the network translation device if the first device has functionality that is controllable via a first protocol; and
sending first device functionality information from the network translation device to the second device via the first protocol if the first device has functionality that is controllable via the first protocol.

6. A method as recited in claim 5, further comprising the following steps before the step of sending first device functionality information from the network translation device to the second device:
notifying the second device via the first protocol that the first device has functionality that is controllable via the first protocol if the first device has functionality that is controllable via the first protocol; and
receiving a request via the first protocol from the second device for first device functionality information at the network translation device.

7. A method as recited in claim 5, further comprising the steps of:
sending a command for invoking functionality of the first device from the second device to the network translation device via the first protocol if the first device has functionality that is controllable via the first protocol;
translating the command from a first protocol format into a second protocol format at the network translation device; and
sending the translated command from the network translation device to the first device via a second protocol.

8. A method as recited in claim 5, wherein the step of determining at the network translation device if the first device has functionality that is controllable via the first protocol comprises the steps of:
associating a memory module with the first device at the network translation device; and
determining if the memory module contains data associated with functionality provided by the first device.

9. A method as recited in claim 8, wherein the step of sending first device functionality information from the network translation device to the second device if the first device has functionality that is controllable via the first protocol comprises the step of:
sending at least one message containing the data associated with functionality provided by the first device from the network translation device to the second device via the first protocol if the memory module contains data associated with functionality provided by the first device.

10. A method as recited in claim 5, wherein the first protocol is selected from the group consisting of Jini protocol, Salutation protocol, and Universal Plug and Play (UPnP) protocol.

11. A method of controlling a first device by a second device via communication with a network translation device, comprising the steps of:
configuring a communication port on the network translation device for communication with the first device, comprising the steps of:
providing a memory module having communication port configuration data that is associated with the first device stored thereon;
associating the memory module with the communication port; and
configuring the communication port based on the communication port configuration data stored on the memory module;
determining if the memory module contains data associated with functionality provided by the first device that is controllable via a first protocol; and
sending at least one message containing the data associated with the functionality provided by the first device from the network translation device to the second device via the first protocol if the memory module contains data associated with functionality provided by the first device that is controllable via the first protocol.

12. A method as recited in claim 11, further comprising the steps of:
sending a command for invoking functionality of the first device from the second device to the network translation device via the first protocol if the memory module contains data associated with functionality provided by the first device that is controllable via the first protocol;
translating the command from a first protocol format into a second protocol format at the network translation device; and
sending the translated command from the network translation device to the first device over the configured communication port via the second protocol.

13. A network translation device, comprising:
a communication port;
a memory module having communication port configuration data stored thereon, the memory module being associated with the communication port; and
a processor that is communicatively coupled to the memory module and that configures the communication port based on the communication port configuration data stored on the memory module.

14. A network translation device as recited in claim 13, wherein the memory module is a non-volatile memory cartridge.

15. A network translation device as recited in claim 13, further comprising:
data associated with functionality provided by a first device stored on the memory module.

16. A network translation device as recited in claim 15, wherein the processor is configured to send at least one message containing the data associated with functionality provided by the first device to a second device.

17. A network translation device as recited in claim 16, wherein the network translation device further comprises:
a memory that is communicatively coupled to the processor and having command translation data stored thereon.

18. A network translation device as recited in claim 17, wherein the processor is configured to translate a command received from the second device for invoking functionality of the first device and having a first protocol format into a second protocol format based on the command translation data, and is further configured to send the translated command to the first device.

19. A system for configuring a communication port for communication with a device, comprising:
means for providing a memory module having communication port configuration data that is associated with the device stored thereon;
means for associating the memory module with the communication port; and
means for configuring the communication port based on the communication port configuration data stored on the memory module.

20. A system as recited in claim 19, wherein the memory module is a nonvolatile memory cartridge.

21. A system as recited in claim 20, wherein the means for associating the memory module with the communication port comprises:
means for associating a memory module slot with the communication port; and
means for inserting the non-volatile memory cartridge into the memory module slot.

22. A system as recited in claim 19, wherein the communication port is a serial port and the communication port configuration data comprises a baud rate and a format for arranging data bits, stop bits, and parity bits in a serial transmission.

23. A system for controlling a first device by a second device via communication with a network translation device, comprising:
means for determining at the network translation device if the first device has functionality that is controllable via a first protocol; and
means for sending first device functionality information from the network translation device to the second device via the first protocol if the first device has functionality that is controllable via the first protocol.

24. A system as recited in claim 23, further comprising:
means for notifying the second device via the first protocol that the first device has functionality that is controllable via the first protocol if the first device has functionality that is controllable via the first protocol; and
means for receiving a request via the first protocol from the second device for first device functionality information at the network translation device;
wherein the means for sending first device functionality information from the network translation device to the second device is responsive to the means for receiving a request via the first protocol from the second device for first device functionality information at the network translation device.

25. A system as recited in claim 23, further comprising:
means for sending a command for invoking functionality of the first device from the second device to the network translation device via the first protocol if the first device has functionality that is controllable via the first protocol;
means for translating the command from a first protocol format into a second protocol format at the network translation device; and
means for sending the translated command from the network translation device to the first device via a second protocol.

26. A system as recited in claim 23, wherein the means for determining at the network translation device if the first device has functionality that is controllable via the first protocol comprises:
means for associating a memory module with the first device at the network translation device; and
means for determining if the memory module contains data associated with functionality provided by the first device.

27. A system as recited in claim 26, wherein the means for sending first device functionality information from the network translation device to the second device if the first device has functionality that is controllable via the first protocol comprises:
means for sending at least one message containing the data associated with functionality provided by the first device from the network translation device to the second device via the first protocol if the memory module contains data associated with functionality provided by the first device.

28. A system as recited in claim 23, wherein the first protocol is selected from the group consisting of Jini protocol, Salutation protocol, and Universal Plug and Play (UPnP) protocol.

29. A system for controlling a first device by a second device via communication with a network translation device, comprising:
means for configuring a communication port on the network translation device for communication with the first device, comprising:
means for providing a memory module having communication port configuration data that is associated with the first device stored thereon;
means for associating the memory module with the communication port; and
means for configuring the communication port based on the communication port configuration data stored on the memory module;
means for determining if the memory module contains data associated with functionality provided by the first device that is controllable via a first protocol; and
means for sending at least one message containing the data associated with the functionality provided by the first device from the network translation device to the second device via the first protocol if the memory module contains data associated with functionality provided by the first device that is controllable via the first protocol.

30. A system as recited in claim 29, further comprising:
means for sending a command for invoking functionality of the first device from the second device to the network translation device via the first protocol if the memory module contains data associated with functionality provided by the first device that is controllable via the first protocol;
means for translating the command from a first protocol format into a second protocol format at the network translation device; and
means for sending the translated command from the network translation device to the first device over the configured communication port via the second protocol.

31. A computer program product for configuring a communication port for communication with a device, comprising:
a computer readable storage medium having computer readable program code embodied therein, the computer readable program code comprising:
computer readable program code for providing a memory module having communication port configuration data that is associated with the device stored thereon;
computer readable program code for associating the memory module with the communication port; and
computer readable program code for configuring the communication port based on the communication port configuration data stored on the memory module.

32. A computer program product as recited in claim 31, wherein the memory module is a non-volatile memory cartridge.

33. A computer program product as recited in claim 32, wherein the computer readable program code for associating the memory module with the communication port comprises:
computer readable program code for associating a memory module slot with the communication port; and
computer readable program code for inserting the non-volatile memory cartridge into the memory module slot.

34. A computer program product as recited in claim 31, wherein the communication port is a serial port and the communication port configuration data comprises a baud rate and a format for arranging data bits, stop bits, and parity bits in a serial transmission.

35. A computer program product for controlling a first device by a second device via communication with a network translation device, comprising:
a computer readable storage medium having computer readable program code embodied therein, the computer readable program code comprising:
computer readable program code for determining at the network translation device if the first device has functionality that is controllable via a first protocol; and
computer readable program code for sending first device functionality information from the network translation device to the second device via the first protocol if the first device has functionality that is controllable via the first protocol.

36. A computer program product as recited in claim 35, further comprising:
computer readable program code for notifying the second device via the first protocol that the first device has functionality that is controllable via the first protocol if the first device has functionality that is controllable via the first protocol; and
computer readable program code for receiving a request via the first protocol from the second device for first device functionality information at the network translation device;
wherein the computer readable program code for sending first device functionality information from the network translation device to the second device is responsive to the computer readable program code for receiving a request via the first protocol from the second device for first device functionality information at the network translation device.

37. A computer program product as recited in claim 35, further comprising:
computer readable program code for sending a command for invoking functionality of the first device from the second device to the network translation device via the first protocol if the first device has functionality that is controllable via the first protocol;
computer readable program code for translating the command from a first protocol format into a second protocol format at the network translation device; and
computer readable program code for sending the translated command from the network translation device to the first device via a second protocol.

38. A computer program product as recited in claim 35, wherein the computer readable program code for determining at the network translation device if the first device has functionality that is controllable via the first protocol comprises:
computer readable program code for associating a memory module with the first device at the network translation device; and
computer readable program code for determining if the memory module contains data associated with functionality provided by the first device.

39. A computer program product as recited in claim 38, wherein the computer readable program code for sending first device functionality information from the network translation device to the second device if the first device has functionality that is controllable via the first protocol comprises:
computer readable program code for sending at least one message containing the data associated with functionality provided by the first device from the network translation device to the second device via the first protocol if the memory module contains data associated with functionality provided by the first device.

40. A computer program product as recited in claim 35, wherein the first protocol is selected from the group consisting of Jini protocol, Salutation protocol, and Universal Plug and Play (UPnP) protocol.

41. A computer program product for controlling a first device by a second device via communication with a network translation device, comprising:
a computer readable storage medium having computer readable program code embodied therein, the computer readable program code comprising:
computer readable program code for configuring a communication port on the network translation device for communication with the first device, comprising:
computer readable program code for providing a memory module having communication port configuration data that is associated with the first device stored thereon;
computer readable program code for associating the memory module with the communication port; and
computer readable program code for configuring the communication port based on the communication port configuration data stored on the memory module;
computer readable program code for determining if the memory module contains data associated with functionality provided by the first device that is controllable via a first protocol; and
computer readable program code for sending at least one message containing the data associated with the functionality provided by the first device from the network translation device to the second device via the first protocol if the memory module contains data associated with functionality provided by the first device that is controllable via the first protocol.

42. A computer program product as recited in claim 41, further comprising:
computer readable program code for sending a command for invoking functionality of the first device from the second device to the network translation device via the first protocol if the memory module contains data associated with functionality provided by the first device that is controllable via the first protocol;
computer readable program code for translating the command from a first protocol format into a second protocol format at the network translation device; and
computer readable program code for sending the translated command from the network translation device to the first device over the configured communication port via the second protocol.
